(19) United States
(12) Patent Application Publication
(10) Pub. No.: US 2018/0179905 A1
(43) Pub. Date: Jun. 28, 2018

(54) COMPONENT HAVING IMPINGEMENT COOLED POCKETS FORMED BY RAISED RIBS AND A COVER SHEET DIFFUSION BONDED TO THE RAISED RIBS

(71) Applicant: Siemens Aktiengesellschaft, München (DE)

(72) Inventors: Timothy A. Fox, Hamilton (CA); Brede Kolsrud, San Mateo, CA (US); Jacob William Hardes, Charlotte, NC (US)

(21) Appl. No.: 15/736,162

(22) PCT Filed: Aug. 6, 2015
(86) PCT No.: PCT/US15/43966

§ 371 Date: Dec. 13, 2017

(51) Int. Cl. F01D 9/02; F01D 25/12

(52) U.S. Cl. CPC F01D 9/023; F01D 25/12; F05D 2260/202; F05D 2230/23; F05D 2250/132; F05D 2260/22141; F05D 2220/32; F05D 2240/35; F05D 2260/201

(57) ABSTRACT

A gas turbine engine component (10), having: a base layer (60) including an array (110) of pockets (52) separated by raised ribs (36), and a film cooling hole (70) through the base layer in each pocket; and a cover sheet (62) diffusion bonded to the raised ribs and including an impingement hole (72) for each pocket of the array of pockets. The raised ribs include a thickness (104) that is less than half of a smallest dimension (96) of the pocket. The component is configured to receive combustion gases from a combustor and accelerate and deliver the combustion gases onto a first row of turbine blades without a turning vane.

### FIELD OF THE INVENTION

The invention relates to components having impingement cooling for surfaces having raised ribs.

### BACKGROUND OF THE INVENTION

Conventional can annular gas turbine engines include several individual combustor cans that are disposed radially outside of and axially aligned with a rotor shaft. Combustion gases produced in the combustor are guided radially inward and then transitioned to axial movement by a transition duct. Turning vanes receive the combustion gases and accelerate and turn them to a vector appropriate for delivery onto a first stage of turbine blades.

A recent ducting structure dispenses with the turning vanes by creating straight flow paths from reoriented combustors directly onto the first stage of turbine blades. One configuration of such a ducting structure is disclosed in U.S. Pat. No. 8,276,389 to Charron et al., which is incorporated by reference herein in its entirety. In such ducting configurations, reoriented combustor cans (not shown) exhaust a respective flow of combustion gases along a vector having both an axial component and a circumferential component, but not a radial component. The flows of combustion gases are accelerated along respective flow paths and are united in an annular chamber to form a single flow. The single flow is delivered to the first stage of turbine blades at the appropriate speed and angle without any intervening turning vanes.

Accelerating the combustion gases to the speed appropriate for delivery onto the first row of turbine blades creates a substantial pressure difference between compressed air in the plenum surrounding the combustion gases and the combustion gases themselves. Forces resulting from this pressure difference must be borne by the structure that separates the combustion gases from the compressed air. In the conventional arrangement, where the first row of turning vanes accelerates the combustion gases from approximately 0.2 Mach in the transition duct to just under Mach speed, the turning vanes are separate, relatively more substantial structures and bear this substantial force readily. Since the combustion gases in the transition duct are only traveling at approximately 0.2 Mach in the conventional arrangement, the transition duct must only bear the forces created by a much smaller pressure difference of approximately 0.3 bar. Further, while these conventional transition ducts may include cooling paths therethrough, the cooling flow therein is limited to convection cooling, typically along channels within the transition duct wall. The relatively low pressure difference is not enough to form true impingement cooling jets.

In contrast, in the recent ducting structures without the turning vane, the acceleration of the combustion gases occurs in the ducting, which historically has been relatively less structurally substantial. To ensure the ducting can bear the forces, structural raised ribs may be employed on the side of the ducting exposed to the compressed air. Exposure of the other side of the ducting to the relatively hot combustion gases necessitates that the side of the ducting exposed to the compressed air be cooled. However, the raised ribs create pockets that are difficult to cool using conventional ducting cooling arrangement. Consequently, there remains room in the art for improvement.

### BRIEF DESCRIPTION OF THE DRAWINGS

The invention is explained in the following description in view of the drawings that show:

FIG. 1 shows an exemplary embodiment of a component having a hollow panel disclosed herein.

FIG. 2 is a perspective view of a section of the hollow panel of FIG. 1.

FIG. 3 is a side view of the section of FIG. 2.

FIG. 4 is a top view of the section of FIG. 2.

FIG. 5 is a schematic view of a rib intersection.

### DETAILED DESCRIPTION OF THE INVENTION

The present inventors have developed a hollow panel having a base layer with raised ribs that enclose pockets and a cover sheet that is diffusion bonded to the raised ribs. The panel may be exposed to a high thermal gradient as part of, for example, a component in a gas turbine engine that defines a hot gas path for combustion gases. The cover sheet includes impingement cooling holes designed to take advantage of the greater pressure gradient and create impingement jets that cool a landing between the raised ribs and/or side surfaces of the raised ribs. This intimate contact resulting from the diffusion bonding enables a relatively high degree of thermal conductivity between the raised ribs and the cover sheet when compared to prior art arrangements where the cover sheet is welded or fastened in place. (I.e. where the cover sheet is relatively thermally free of the base layer.) This high degree of thermal conduction conducts heat from the ribs into the cover sheet, which heats the cover sheet to a temperature closer to that of the base layer, thereby creating a panel having a more uniform temperature. This more uniform temperature decreases thermal growth mismatches and associated thermal stresses between the base layer and the cover sheet when compared to welded arrangements, which increases a lifespan of the panel. The pockets and ribs may be sized and shaped to strike a balance between mechanical strength of the panel, thermal stress within the panel, and the amount of cooling air consumption.

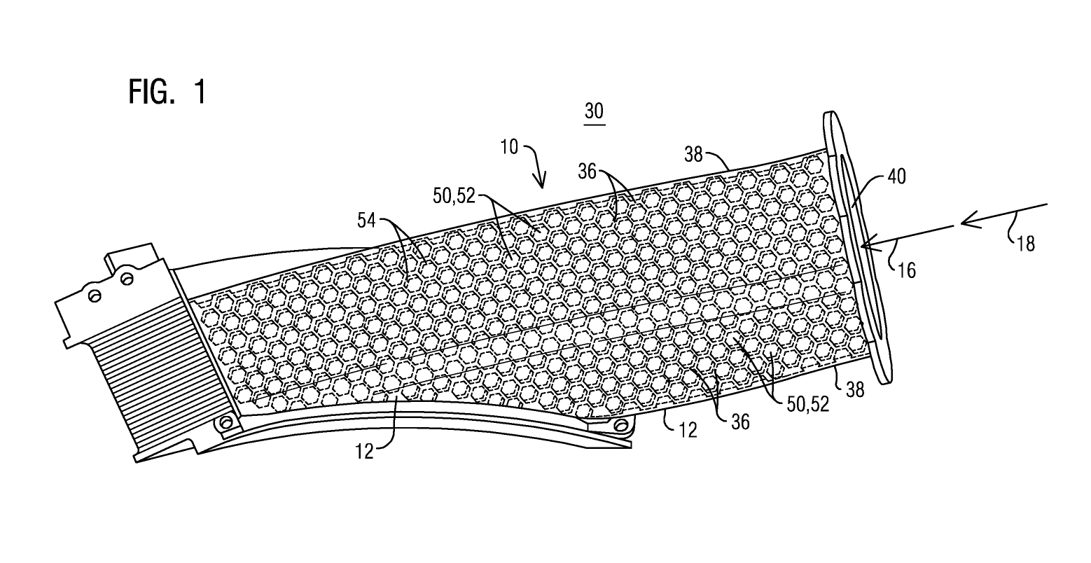

FIG. 1 shows one exemplary embodiment of a component 10 that is part of a ducting structure having a hollow panel 12 and used to receive combustion gases from a combustor (not shown) and deliver them to a turbine (not shown) without a turning vane. This exemplary embodiment is not meant to be limiting. For example, it may be shorter, longer, and/or have a greater or smaller diameter etc. In this exemplary embodiment the component 10 includes a combustion gas path 16 that guides a respective discrete flow 18 of combustion gases from a combustor toward a first row of turbine vanes (not shown). When plural components 10 are assembled together a downstream end 20 joins with downstream ends of adjacent components to form an annular shape (not shown) that matches a shape of an inlet (not shown) to the first row of turbine blades. A single, unified annular flow of combustion gases is thereby delivered onto the first row of turbine blades. Since there are no turning vanes in this configuration, the flow 18 of combustion gases is otherwise accelerated to a speed appropriate for delivery onto the first row of turbine blades (e.g. nearly Mach speed). The acceleration of the combustion gases may be the result of a reduction in a flow area between the combustor and the first stage of turbine blades. The reduction in flow area may begin upstream of the combustion gas path 16 in, for example, a cone (not shown) between the combustor and the combustion gas path 16. The flow area reduction may be essentially complete upstream of the combustion gas path 16 as shown. Alternately, the reduction in flow area may continue in the combustion gas path 16.

The component 10 may be disposed in a plenum 30 filled with compressed air at a relatively high pressure compared to the combustion gases in the combustion gas path 16. One approach to providing sufficient structural strength for the hollow panel 12 is to incorporate raised ribs 36 on a cooled side 38, while leaving a hot gas path side 40 smooth. In the configuration shown the raised ribs 36 have a pocket landing 50 between respective raised ribs 36. The raised ribs 36 may enclose a pocket 52 having sides 54. As used herein, a pocket 52 includes at least two sides 54 and a pocket landing 50. The pocket 52 may include a sufficient number of sides 54 to fully enclose the pocket 52. The pockets 52 may be disposed along the combustion gas path 16 and may extend some or all of the way from there the combustions gases enter the combustion gas path 16 to where the combustion gases exit.

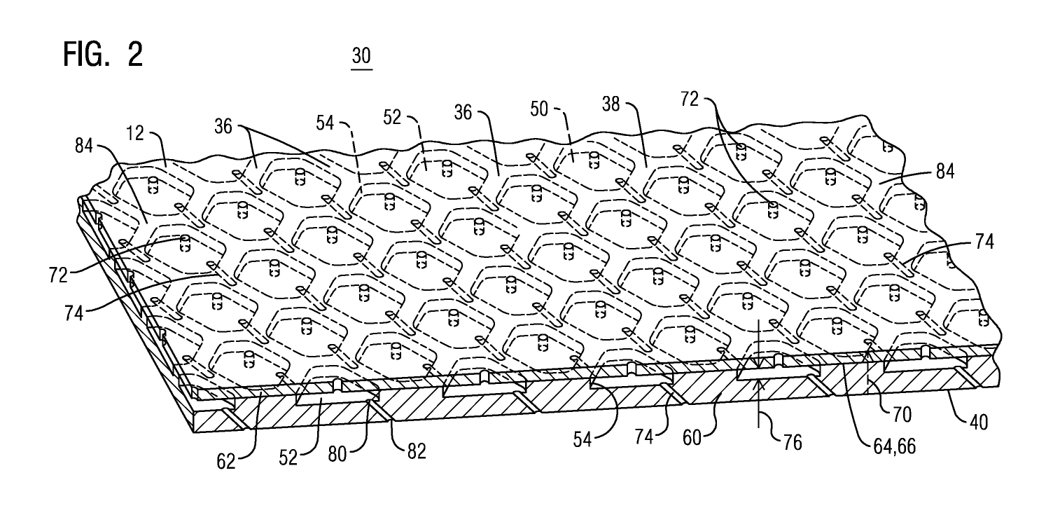

FIG. 2 is a perspective view of the hollow panel 12 of FIG. 1 showing the base layer 60 and the cover sheet 62. The cover sheet 62 is diffusion bonded to an upper surface 64 of the raised ribs 36 of the base layer 60 to form in a diffusion bond region 66. The intimate contact created at a diffusion bond region 66 creates a conduction path 70 from the hot gas path side 40 to the cooled side 38. This conduction path 70 is better at conducting heat than in arrangements where the cover sheet is, for example, welded or fastened to the base layer, because the contact in those configurations contact is much less intimate. The better conduction allows the cover sheet 62 to absorb more heat, thereby reaching a temperature that is closer to a temperature of the base layer 60. When these two sheets are closer in temperature, thermal growth mismatch and associated thermal stresses are reduced. When the component 10 is a duct for combustion gases, the base layer 60 and the cover sheet 62 are then cooled by compressed air in a plenum surrounding the component 10.

To the contrary, in configurations where the cover sheet 62 is fastened or welded to the base layer 60, thermal conductivity at the interface between the base layer 60 and the cover sheet 62 is relatively low. In this case the interface is much less efficient at conducting heat between the base layer 60 and the cover sheet 62, resulting in significantly reduced cooling of the base layer 60 when compared to the diffusion bonded exemplary embodiment disclosed herein. The result is a relatively hot base layer 60 and a cover sheet 62 at a temperature that is close to the temperature of the compressed air in the plenum, where the two are separated by the relatively poor conducting interface. This results in thermal mismatch and associated thermal stress, particularly in welded configurations where the base layer 60 and the cover sheet 62 are mechanically fixed to each other. This, in turn, reduces the lifespan of the component 10.

The cover sheet 62 may include an impingement hole 72 for some or all of the pockets 52. The impingement hole 72 may direct an impingement jet onto the landing 50 and/or onto the sides 54 of the pocket 52. The impingement hole 72 may direct the impingement jet toward a center of the landing 50 and post impact impingement cooling air may spread radially outward from an impact point, after which it may exit the pocket 52 through a respective film cooling hole 74.

Each film cooling hole 74 has a film cooling hole inlet 80 and a film cooling hole outlet 82. In an exemplary embodiment the film cooling hole outlet 82 may be disposed under or slightly upstream (with respect to a flow of hot gases) of a rib intersection 84 of the raised ribs 36. This delivers film cooling air directly under the rib intersection 84 where the impingement cooling is least effective. This, in turn, reduces temperature gradients on the hot gas path side 40, thereby reducing associated thermal stresses.

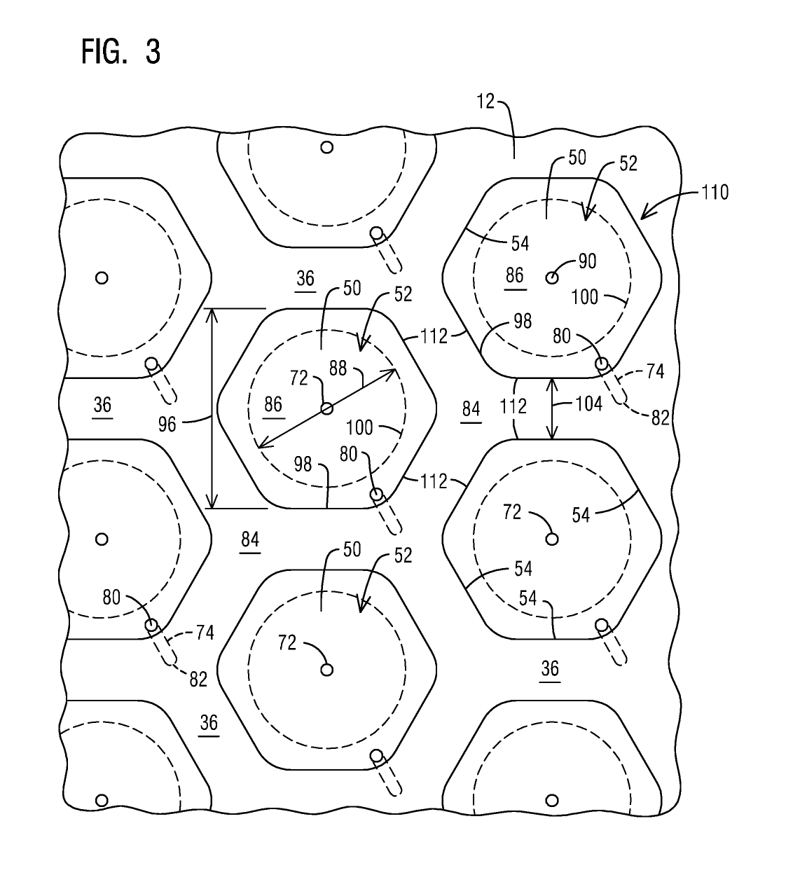

As can be seen in FIG. 3, which is a top view of the panel 12 of FIG. 2, the pockets 52 themselves may have a polygon shape, such as hexagonal, and may be sized to maximize the cooling effect/splashdown zone 86 of the impingement jet that may be characterized by a splashdown zone diameter 88. The splashdown zone 86 may be defined as an impingement zone where the heat flux is at least twenty (20) percent of the highest heat flux created by the impingement jet. The highest heat flux usually occurs at or near a stagnation point 90 of the impingement jet on the landing 50. A smallest dimension 96 (e.g. smallest diameter) of the pocket 52 may be sized to cooperate with the splashdown zone 86 such that an area 98 of the landing 50 is only slightly larger than an area 100 of the of the splashdown zone 86. The area 98 of the landing 50 would likely be larger than the area 100 of the splashdown zone 86 because the spent cooling air traveling laterally along the landing 50 (i.e. the wall jet) would interact with the sides 54 of the raised ribs 36, causing the spent cooling air to curl back on itself. This effect may be reduced close to the film cooling hole inlet 80 because some of the spent cooling air will exit through the film cooling hole 74, thereby mitigating the interaction with the sides 54 locally.

The raised ribs 36 between the pockets 52 are characterized by a rib thickness 104 that strikes a balance between structural strength of the panel 12, engine operating efficiency, and thermal stresses in the panel 12. Increased rib thickness 104 is desirable because it provides increased structural integrity needed to withstand a relatively high pressure gradient across the panel 12, and because it reduces cooling air consumption (thicker raised ribs 36 in a same area means fewer pockets to cool, which means reduced cooling air consumption). Decreased rib thickness 104 is desirable because the raised ribs 36 are only cooled by conduction, while adjacent landings 50 are impingement cooled. Relatively reduced cooling at the raised ribs 36 increases a temperature under the raised ribs 36 (i.e. on the hot gas path side 40 of the panel 12) relative to a temperature under the impingement cooled landings 50, resulting in relatively hot regions under the raised ribs 36. (The thicker the raised rib 36, the greater the local increase in temperature there under.) Therefore, reducing the rib thickness 104 reduces temperature gradients and associated thermal stresses on the hot gas path side 40 of the panel 12. Thus, increased rib thickness 104 increases mechanical strength of the panel 12 and increases operating efficiency of the gas turbine engine, but also increases thermal stress within the panel 12. Conversely, decreases rib thickness 104 decreases mechanical strength of the panel 12 and decreases operating efficiency of the engine, but also decreases thermal stresses in the panel 12. The design and dimension disclosed herein strike an optimal balance between these factors.

In an exemplary embodiment, a rib thickness 104 of five millimeters and a smallest dimension 96 (flat side to flat side) of the hexagonal pocket 52 of twelve millimeters strikes a desirable balance. More broadly stated, the rib thickness 104 may be less than half the smallest dimension 96 and obtain a desirable balance. Twelve millimeters is only slightly larger than the splashdown zone diameter 88 in an exemplary embodiment, thereby maximizing the impingement cooling effect within the pocket 52. In such an exemplary embodiment the impingement hole 72 may have a diameter of less than one (1) millimeter. In an exemplary embodiment the impingement hole 72 may have a diameter of approximately 0.6 millimeters.

An additional benefit of these dimensions is that it is amendable to the process used to form the panel 12. More specifically, the base layer 60 may be formed from a flat sheet into the desired component shape. The cover sheet 62 may then be placed on the base layer 60 and formed over the base layer 60 to match the base layer 60. If there is too much distance between the raised ribs 36, when the cover sheet 62 is formed around the base layer 60 the cover sheet 62 may “sag” into pockets 52, particularly on a bend (convex corner) of the base layer 60. Maintaining a sufficient number and dimension of the raised ribs 36 to the number and dimension of the pockets 52 prevents this sagging which, in turn, ensures a consistent pocket depth 124 between the cover sheet 62 and the respective landing 50 throughout the panel 12. The consistent pocket depth 124 ensures uniform cooling.

The pockets 52 may form an array 110 and the array 110 may be patterned such that the pockets 52 are staggered, and sides 54 of adjacent pockets 52 are parallel to each other. When the walls 54 of three adjacent pockets 112 are parallel, and the rib thickness 104 is consistent, then three raised ribs 36 meet at the rib intersection 84 and the intersecting raised ribs 36 are equally distributed angularly about the rib intersection 84. Such a pattern throughout the array 110 has been found to provide uniform cooling and relatively small thermal gradients.

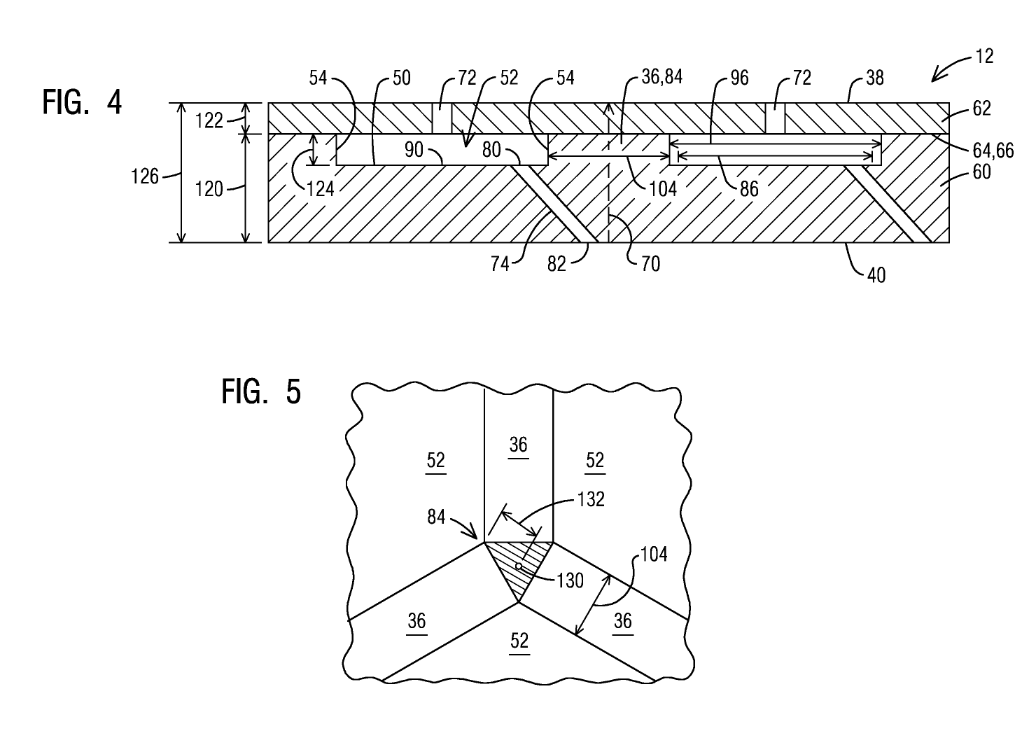

FIG. 4 is a side view of the panel 12 of FIG. 2, showing the base layer 60 and the cover sheet 62. In an exemplary embodiment either or both the base layer 60 and the cover sheet 62 may include a high nickel superalloy. Forming the base layer 60 and/or the cover sheet 62 using sheet material provides advantages over forming either via casting. For example, using sheet material allows for thinner panels 12 having the same strength as the thicker cast counterparts. This, in turn, enables lighter and easier to cool components that have longer life due to reduced thermal mismatches. Further, thinner panels 12 also allow for improved junctions where adjacent gas flows meet, providing for more aerodynamic flow at the junction.

The base layer 60 is characterized by a base layer thickness 120, the cover sheet 62 is characterized by a cover sheet thickness 122, the pocket 52 is characterized by a pocket depth 124, and the panel is characterized by a panel thickness 126. In an exemplary embodiment the cover sheet thickness 122 is at least twenty five percent of the base layer thickness 120. However, this ratio is not meant to be limiting. For example, if the pressure gradient is increased, the base layer thickness 120 might increase, but the cover sheet thickness 122 would likely remain the same, effectively changing the ratio. With this ratio the cover sheet 62 becomes structurally significant, providing rigidity and strength to the panel 12 that the panel 12 may need in order to overcome the relatively high pressure gradient across the panel 12. In such an exemplary embodiment, the construction of the panel 12 resembles that of a structural beam more than a simply layered panel.

In an exemplary embodiment the base layer thickness 120 may be 4.8 millimeters, the cover sheet thickness 122 may be 1.6 millimeters, and the resulting panel thickness 126 may be 6.4 millimeters. The pocket depth may be 1.6 millimeters. This represents a significant reduction in thickness when compared to configurations where the base layer 60 is cast. When cast, the base layer thickness may be ten (10) millimeters, and the cover sheet thickness may be 0.5 millimeters, providing an overall thickness closer to 10.5 millimeters. Accordingly, using sheet material may provide for a thinner, easier to cool component having the same strength and greater lifespan than larger cast counterparts. Transition ducts in conventional arrangements, which are configured to deliver un-accelerated combustion gases at approximately 0.2 Mach to a turning vane, where they are turned and accelerated for delivery onto the first row of turbine blades, may have a thickness on the order of approximately 1.6 millimeters. This reduced thickness is sufficient due to the relatively low pressure gradient experienced when conducting relatively slow combustion gases.

FIG. 5 shows a rib intersection 84 where three raised ribs 36 intersect and are uniformly angularly positioned around the rib intersection 84, which results from the pattern of hexagonal pockets 52 disclosed herein. In this configuration this rib intersection 84 forms a triangle having a center 130 disposed at a center distance 132 from the nearest landing 52. When compared to an intersection where, for example, four raised ribs, each at ninety degrees to the other, thereby forming a square rib intersection, the center distance 132 is smaller. For example, in an exemplary embodiment where the raised ribs 36 are characterized by a rib thickness 104 of five millimeters, the center distance 130 in FIG. 5 is approximately 3.3 millimeters, which compares to a center distance of approximately 3.5 millimeters for a square rib intersection. Since smaller center distances 132 result in a smaller local temperature rise under the rib intersection 84, the smaller center distance 132 contributes to more uniform temperatures across the hot gas path surface 40. In addition, when hexagonal pockets 52 are used as disclosed herein, the array 110 forms a staggered pattern, and this results in a staggered pattern for the film cooling holes 74. This provides for uniform film of cooling air on the hot gas path side 40.

While the preceding disclosure has focused on the panel 12 being used in an advanced transition duct that experiences the relatively high pressure difference, the structure can be applied to conventional transition ducts. While the lower pressure gradient in the conventional arrangement may not produce true impingement cooling, it may provide a more uniformly cooled and relatively stronger conventional transition duct.

From the foregoing it can be seen that the inventors have created a gas turbine engine hot gas path component having a panel suitable for use in relatively high pressure gradient environments, where the structure is sufficient to maximize strength, minimize thickness, minimize thermal stress, and control an amount of cooling air flowing therethrough, while significantly improving the lifespan of a component using the panel. Consequently, this represents an improvement in the art.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

1. A gas turbine engine component, comprising:
a base layer comprising an array of pockets separated by raised ribs, and a film cooling hole through the base layer in each pocket; and
a cover sheet diffusion bonded to the raised ribs and comprising an impingement hole for each pocket of the array of pockets,
wherein the raised ribs comprise a thickness that is less than half of a smallest dimension of the pocket, and
wherein the component is configured to receive combustion gases from a combustor and accelerate and deliver the combustion gases onto a first row of turbine blades without a turning vane.

2. The component of claim 1, wherein the base layer and the cover sheet both comprise a wrought sheet material.

3. The component of claim 1, wherein the cover sheet comprises a thickness of at least twenty-five percent of a thickness of the base layer.

4. The component of claim 1, wherein each pocket comprises a hexagonal shape.

5. The component of claim 4, wherein throughout the array of pockets adjacent side walls of three adjacent pockets are aligned with each other and wherein the raised ribs form rib intersections between the three adjacent pockets where three raised ribs meet.

6. The component of claim 5, wherein each film cooling hole comprises a film cooling hole outlet disposed under a respective rib intersection.

7. The component of claim 1, the base layer defining a flow path comprising a flow area sized to deliver the received combustion gases at a speed appropriate for delivery onto the first row of turbine blades, wherein the array of pockets surrounds the flow path.

8. A gas turbine engine component, comprising:
a flow path comprising an inlet configured to receive combustion gases from a combustor and a flow area sized to deliver the received combustion gases at a speed appropriate for delivery onto a first row of turbine blades without a turning vane;
a base layer that defines the flow path for the combustion gases, comprising an array of pockets disposed around the flow path, the array of pockets defined by raised ribs;
a cover sheet diffusion bonded to the raised ribs and comprising an impingement hole therethrough for each pocket.

9. The component of claim 8, wherein the pockets comprise a hexagonal shape.

10. The component of claim 8, wherein the raised ribs comprise a uniform thickness and define a consistent and staggered pattern to the array of pockets.

11. The component of claim 8, wherein the raised ribs define rib intersections where only three raised ribs intersect.

12. The component of claim 8, wherein the raised ribs comprise a thickness of less than half of a smallest dimension of the pocket.

13. The component of claim 11, the base layer further comprising a film cooling hole in each pocket, each film cooling hole comprising a film cooling hole outlet disposed under a respective rib intersection.

14. The component of claim 8, wherein the base layer and the cover sheet both comprise a wrought sheet material.

15. The component of claim 8, wherein the cover sheet comprises a thickness of at least twenty-five percent of a thickness of the base layer.

16. A gas turbine engine component, comprising:
a base layer comprising an array of pockets separated by raised ribs, and a film cooling hole through the base layer in each pocket; and
a cover sheet diffusion bonded to the raised ribs and comprising an impingement hole for each pocket of the array of pockets, and
rib intersections where only three raised ribs intersect,
wherein each pocket comprises a hexagonal shape, and
wherein the raised ribs define a constant and staggered spacing of the pockets.

17. The gas turbine engine component of claim 16, wherein the raised ribs comprise a uniform thickness, and wherein the uniform thickness is less than half a smallest dimension of the pocket.

18. The gas turbine engine component of claim 16, wherein the base layer and the cover sheet both comprise sheet material.

19. The gas turbine engine component of claim 16, wherein a thickness of the cover sheet is at least twenty five percent of a thickness of the base layer.
